(19) United States
(12) Patent Application Publication
(10) Pub. No.: US 2017/0373364 A1
(43) Pub. Date: Dec. 28, 2017

(54) CIRCULATOR, FRONT-END CIRCUIT, ANTENNA CIRCUIT, AND COMMUNICATION APPARATUS

(71) Applicant: Murata Manufacturing Co., Ltd., Kyoto (JP)

(72) Inventor: Reiji NAKAJIMA, Kyoto (JP)

(21) Appl. No.: 15/686,281

(22) Filed: Aug. 25, 2017

Related U.S. Application Data
(63) Continuation of application No. PCT/JP2016/053300, filed on Feb. 4, 2016.

(30) Foreign Application Priority Data
Feb. 27, 2015 (JP) 2015-038898

(51) Int. Cl. H01P 1/383; H01Q 1/22; H01Q 7/06; H04B 5/00

(52) U.S. Cl. CPC H01P 1/383; H04B 5/0081; H01Q 1/2225; H01Q 7/06

(57) ABSTRACT

A circulator includes: a ferrite plate; a permanent magnet that applies a direct current (DC) magnetic field to the ferrite plate; a first coil, a second coil, and a third coil arranged on the ferrite plate while being insulated from one another, the first coil, the second coil, and the third coil having coil axes intersecting one another; a first port that is electrically continuous with the first coil; a second port that is electrically continuous with the second coil; and a third port that is electrically continuous with the third coil. An inductance of the first coil or the second coil is different from an inductance of the third coil, and an impedance of the first port or the second port is not 50Ω.

This application is a continuation of International Application No. PCT/JP2016/053300 filed on Feb. 4, 2016 which claims priority from Japanese Patent Application No. JP 2015-038898 filed on Feb. 27, 2015. The contents of these applications are incorporated herein by reference in their entireties.

### BACKGROUND

### Technical Field

The present disclosure relates to a circulator used in a transmission/reception demultiplexing circuit or the like, a front-end circuit, an antenna circuit, and a communication apparatus.

A circulator is used in, for example, a circuit that is connected to an antenna, a transmission circuit, and a reception circuit of a mobile communication device, and that demultiplexes a transmission signal and a reception signal.

Patent Document 1 discloses a demultiplexing circuit configured by providing an impedance matching circuit at each of ports of a circulator to achieve impedance matching among these ports.

Patent Document 1: Japanese Unexamined Patent Application Publication No. 2009-225425

### BRIEF SUMMARY

The circulator used in the above-mentioned demultiplexing circuit is designed such that each port will have 50Ω, which is standard. Therefore, if the impedance of a transmission circuit or a reception circuit connected to each port of the circulator is not 50Ω, an impedance matching circuit is necessary, as discussed in Patent Document 1.

For example, a power amplifier of a transmission circuit included in a small mobile communication apparatus, such as a cellular phone, is a circuit driven by a low power supply voltage, and its impedance is lower than 50Ω, which is the standard in the field of communication devices. Thus, an impedance matching circuit is necessary when such a small antenna is connected to the circulator.

The above-mentioned impedance matching circuit is a circuit including a reactance element that is connected in series with a signal line or a reactance element that is shunt-connected between a signal line and ground. Accordingly, the number of reactance elements necessary for configuring a demultiplexing circuit increases, resulting in a loss caused by these reactance elements. Because impedance matching is achieved by connections of the reactance elements, the impedance is strongly frequency-dependent. Therefore, the more the impedance of a circuit to be matched is away from 50Ω, the narrower the frequency band to match.

The present disclosure provides a circulator to which a radio-frequency (RF) circuit with a certain impedance is connectable without necessarily externally connecting an impedance matching circuit. The present disclosure further provides a front-end circuit, an antenna circuit, and a communication apparatus including the circulator.

(1) A circulator of the present disclosure includes:

a ferrite plate;

a permanent magnet that applies a direct current (DC) magnetic field to the ferrite plate;

a first coil, a second coil, and a third coil arranged on the ferrite plate while being insulated from one another, the first coil, the second coil, and the third coil having coil axes intersecting one another;

a first port that is electrically continuous with the first coil;

a second port that is electrically continuous with the second coil; and

a third port that is electrically continuous with the third coil, wherein:

the permanent magnet applies a DC magnetic field to the ferrite plate such that a signal input to the first port will be output to the third port and a signal input to the third port will be output to the second port, and

an inductance of the first coil or the second coil is different from an inductance of the third coil, and an impedance of the first port or the second port is not 50Ω.

With the above-described configuration, an RF circuit with a certain impedance can be connected without necessarily externally connecting an impedance matching circuit.

(2) For example, the impedance of the first port is less than 50Ω, and the impedance of the second port is 50Ω or higher than the impedance of the first port. With the above-described configuration, an RF circuit with an impedance that is 50Ω or higher than the impedance of the first port and an RF circuit with an impedance that is less than 50Ω can be connected without necessarily having an impedance matching circuit interposed therebetween.

(3) In the above-described (1), for example, the impedance of the first port is a value that exceeds 50Ω, and the impedance of the second port is 50Ω or lower than the impedance of the first port. With the above-described configuration, an RF circuit with an impedance that is 50Ω or lower than the impedance of the first port and an RF circuit with an impedance that exceeds 50Ω can be connected without necessarily having an impedance matching circuit interposed therebetween.

(4) In the above-described (1), for example, the impedance of the first port is less than 50Ω, and the impedance of the second port is a value that exceeds 50Ω. With the above-described configuration, an RF circuit with an impedance that is less than 50Ω and an RF circuit with an impedance that exceeds 50Ω can be connected without necessarily having an impedance matching circuit interposed therebetween.

(5) In addition in (4), for example, an impedance of the third port is less than 50Ω. With the above-described configuration, two RF circuits with an impedance that is less than 50Ω and an RF circuit with an impedance that exceeds 50Ω can be connected without necessarily having an impedance matching circuit interposed therebetween.

(6) In the above-described (1), for example, the impedance of the first port is greater than or equal to 5Ω and less than or equal to 30Ω, the impedance of the second port is greater than or equal to 55Ω and less than or equal to 150Ω, and an impedance of the third port is greater than or equal to 5Ω and less than or equal to 25Ω. With the above-described configuration, two RF circuits with an impedance that is less than 50Ω and an RF circuit with an impedance that exceeds 50Ω can be connected without necessarily having an impedance matching circuit interposed therebetween.

(7) In any one of the above-described (1) to (6), the first coil or the second coil can have a different number of turns of the coil from that of the third coil. Accordingly, the impedance of the first port or the second port of the circulator can be easily made different from the impedance of the third port.

(8) In any one of the above-described (1) to (6), the first coil or the second coil can have a different coil diameter from that of the third coil. Accordingly, the impedance of the first port or the second port of the circulator can be easily made different from the impedance of the third port.

(9) In any one of the above-described (1) to (6), the first coil or the second coil can have a different line width of the coil from that of the third coil. Accordingly, the impedance of the first port or the second port of the circulator can be easily made different from the impedance of the third port.

(10) A front-end circuit of the present disclosure includes: a circulator including a first port to which a transmission signal is input, a second port from which a reception signal is output, and a third port connected to an antenna; and a power amplifier that outputs a transmission signal. The circulator is the circulator according to any one of the above-described (1) to (9).

With the above-described configuration, a front-end circuit where a circuit for impedance matching is omitted can be configured.

(11) In the above-described (10), an output of the power amplifier can be directly connected to the first port. Accordingly, a power loss can be reduced.

(12) A front-end circuit of the present disclosure includes: a circulator including a first port to which a transmission signal is input, a second port from which a reception signal is output, and a third port connected to an antenna; and a low-noise amplifier that receives a reception signal. The circulator is the circulator according to any one of the above-described (1) to (9), and an input of the low-noise amplifier is directly connected to the second port.

With the above-described configuration, a front-end circuit where a circuit for impedance matching is omitted can be configured.

(13) An antenna circuit of the present disclosure includes: a circulator including a first port to which a transmission signal is input, a second port from which a reception signal is output, and a third port connected to an antenna; and the antenna. The circulator is the circulator according to any one of the above-described (1) to (9), and the antenna is directly connected to the third port.

With the above-described configuration, an antenna circuit where a circuit for impedance matching is omitted can be configured.

(14) A communication apparatus of the present disclosure includes: a circulator including a first port to which a transmission signal is input, a second port from which a reception signal is output, and a third port connected to an antenna; a power amplifier that outputs a transmission signal; and an RFIC that outputs a signal to be supplied to the power amplifier. The circulator is the circulator according to any one of above-described (1) to (9), and an output of the power amplifier is directly connected to the first port.

With the above-described configuration, a communication apparatus where a circuit for impedance matching is omitted can be configured.

According to the present disclosure, because an RF circuit with a certain impedance can be directly connected to the circulator, an impedance matching circuit to be externally connected becomes unnecessary. Therefore, the number of elements becomes reduced, thereby achieving low loss characteristics and wide-band characteristics.

### BRIEF DESCRIPTION OF THE SEVERAL VIEWS OF THE DRAWINGS

FIG. 1 is a diagram illustrating the configuration of a front-end circuit portion including a circulator according to a first embodiment.

FIG. 2 is a circuit diagram of a circulator 101.

FIG. 3 is a plan view of the circulator 101.

FIG. 4 is an exploded perspective view of the circulator 101.

FIG. 5 is a diagram illustrating the number of turns of a first coil L1, which is a plan view illustrating first coil conductor patterns formed on a photosensitive glass layer 6T and the like.

FIG. 6 is a cross-sectional view illustrating a coil opening of the first coil L1.

FIGS. 7A, 7B, and 7C are diagrams illustrating the characteristics of the circulator 101 according to the first embodiment.

FIG. 8 is a diagram illustrating selection of the number of turns of each of the first coil L1, a second coil L2, and a third coil L3.

FIG. 9 is a diagram illustrating the schematic relationship between the number of turns of a coil and port impedance defined by the number of turns.

FIG. 10 is a plan view of a circulator 102 according to a second embodiment.

FIGS. 11A, 11B, and 11C are diagrams illustrating the characteristics of the circulator 102 according to the second embodiment.

FIG. 12 is a plan view of a circulator 103 according to a third embodiment.

FIGS. 13A, 13B, and 13C are diagrams illustrating the characteristics of the circulator 103 according to the third embodiment.

FIG. 14 is a plan view of a circulator 104 according to a fourth embodiment.

FIGS. 15A, 15B, and 15C are diagrams illustrating the characteristics of the circulator 104 according to the fourth embodiment.

FIG. 16 is a plan view of a circulator 105 according to a fifth embodiment.

FIGS. 17A, 17B, and 17C are diagrams illustrating the characteristics of the circulator 105 according to the fifth embodiment.

### DETAILED DESCRIPTION

Hereinafter, a plurality of embodiments of the present disclosure will be described by giving a few specific examples with reference to the drawings. In the drawings, the same portions are given the same reference numeral. From a second embodiment onward, descriptions of points that are common to those of a first embodiment will be omitted, and different points will be described. In particular, the same or similar advantageous effects which may be achieved by the same or similar configuration will not be mentioned in each of the embodiments.

### First Embodiment

The first embodiment will discuss an example of a circulator, a front-end circuit, an antenna circuit, and a communication apparatus.

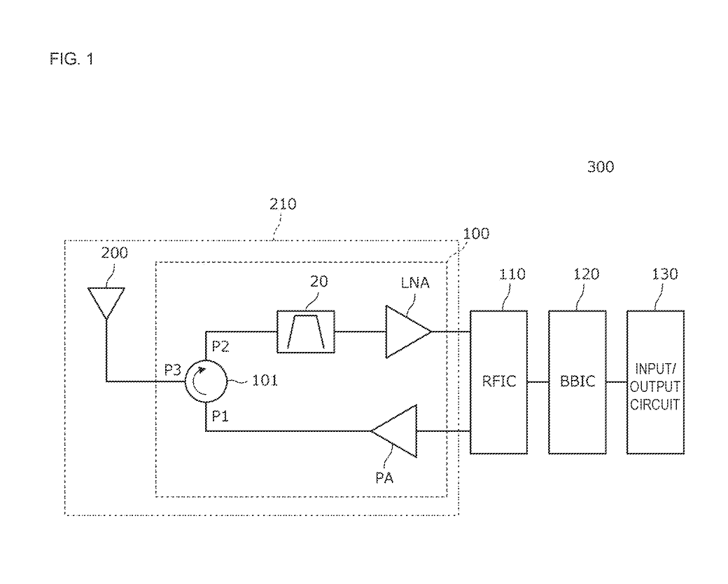

FIG. 1 is a diagram illustrating the configuration of a circulator, a front-end circuit, an antenna circuit, and a communication apparatus 300 according to the first embodiment. A front-end circuit 100 includes a circulator 101, a power amplifier PA, a band-pass filter 20, and a low-noise amplifier LNA. The power amplifier PA amplifies the power of a transmission signal; the band-pass filter 20 cuts off the frequency band of the transmission signal; and the low-noise amplifier LNA amplifies a reception signal. The circulator 101 includes a first port P1 to which a transmission signal is input, a second port P2 from which a reception signal is output, and a third port P3 to/from which a transmission/reception signal is input/output. The power amplifier PA is connected to the first port P1 of the circulator 101; the band-pass filter 20 is connected to the second port P2; and an antenna 200 is connected to the third port P3.

A circuit including the circulator 101 and the antenna 200 configures an antenna circuit. In the present embodiment, the front-end circuit 100 and the antenna 200 configure an antenna circuit 210.

An RFIC (radio-frequency (RF) IC) 110 is connected to the power amplifier PA and the low-noise amplifier LNA. In addition, a BBIC (base-band IC) 120 is connected to the RFIC 110. Furthermore, an input/output circuit 130 such as a display panel, a touchscreen, a loudspeaker, and a microphone is connected to the BBIC 120.

The RFIC 110 outputs a pre-amplified transmission signal to the power amplifier PA, and receives a reception signal amplified by the low-noise amplifier LNA.

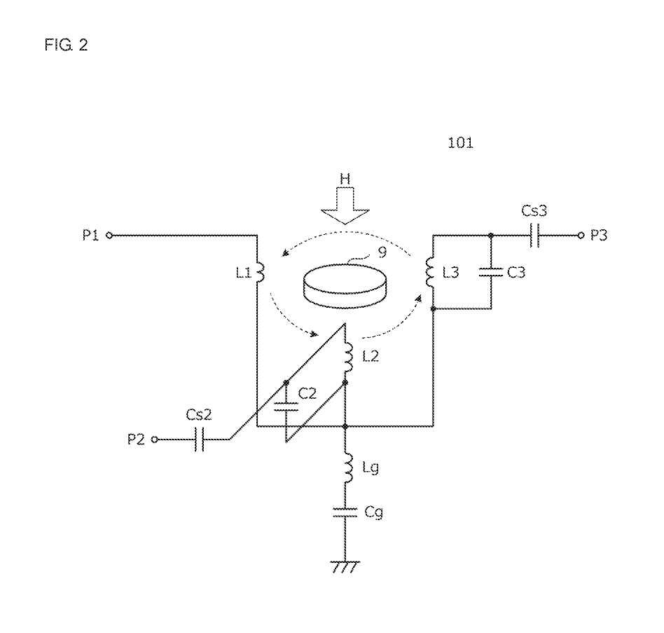

FIG. 2 is a circuit diagram of the circulator 101. A capacitor C2 is connected in parallel with the second coil L2, and a capacitor Cs2 is connected in series between a first end of the second coil L2 and the second port P2. A capacitor C3 is connected in parallel with the third coil L3, and a capacitor Cs3 is connected in series between a first end of the third coil L3 and the third port P3. Second ends of the coils L1, L2, and L3 are commonly connected at one common connection point, and a series circuit including an inductor Lg and a capacitor Cg is provided between the common connection point and ground. A direct current (DC) bias magnetic field H is applied to a ferrite plate 9.

The inductance of the second coil L2 and the capacitance of the capacitors C2 and Cs2 are defined such that the impedance of the second port P2 will be 50Ω. Likewise, the inductance of the third coil L3 and the capacitance of the capacitors C3 and Cs3 are defined such that the impedance of the third port P3 will be 50Ω.

The inductance of the first coil L1 is less than the inductance of the second coil L2 and the third coil L3, and the impedance of the first port P1 is defined as a value less than 50Ω.

As illustrated in FIG. 2, a reactance element for impedance matching (a series-connected capacitor or a shunt-connected capacitor) is not connected to the first coil L1.

As will be described later, the impedance of the three ports P1, P2, and P3 can be independently and arbitrarily set by intentionally changing the inductance of the three coils L1, L2, and L3. The reason the impedance can be independently and arbitrarily changed is that non-reciprocity (isolation) occurs between the ports, causing each of the ports to be equivalently viewed by the other ports as a termination port.

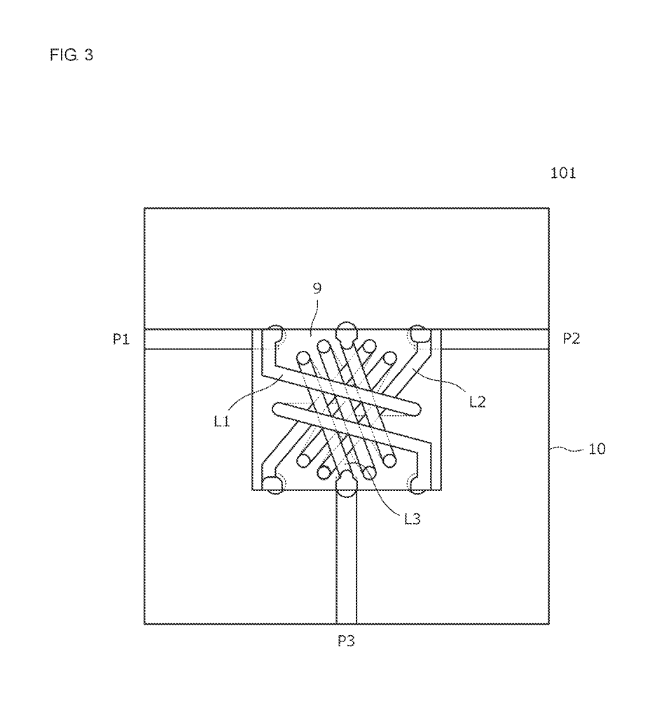

FIG. 3 is a plan view of the circulator 101. The circulator 101 includes a multilayer substrate 10 and a core portion of the circulator. The core portion includes the ferrite plate 9, and the first coil L1, the second coil L2, and the third coil L3, which are formed on the ferrite plate 9. These coils L1, L2, and L3 are configured by linear conductor patterns formed on the top and bottom faces of the ferrite plate 9 and conductor patterns formed on or near the side faces of the ferrite plate 9. The coils L1, L2, and L3 intersect one another on the main face of the ferrite plate 9 while being insulated from one another. Although not illustrated in FIG. 3, the circulator 101 includes magnets that apply a bias magnetic field to the ferrite plate 9. Conductor patterns for configuring the impedance-matching capacitors C2, Cs2, C3, Cs3, and Cg and the inductor Lg, illustrated in FIG. 2, are formed on the multilayer substrate 10. These impedance-matching reactance elements may be provided by mounting chip components, instead of using conductor patterns.

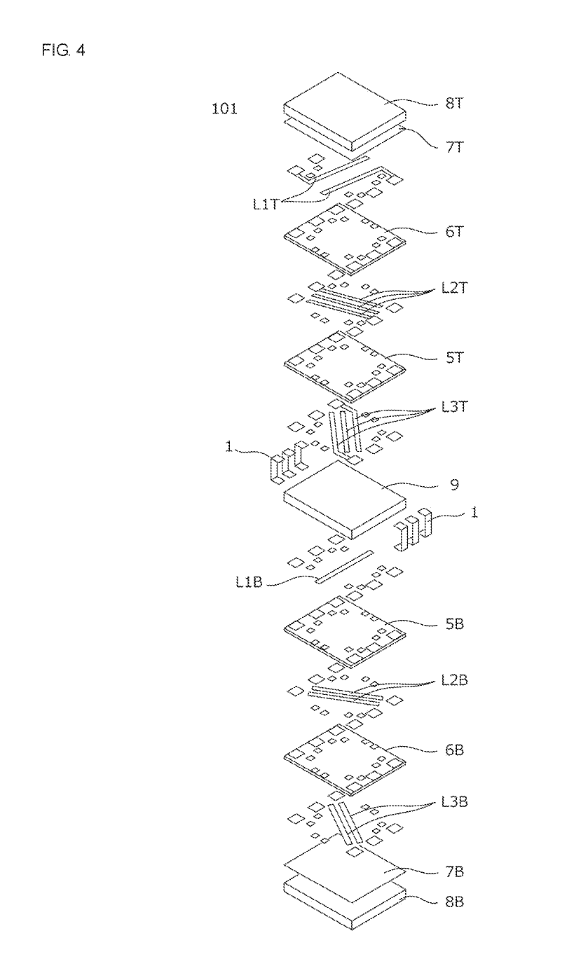

FIG. 4 is an exploded perspective view of the circulator 101. The circulator 101 includes the ferrite plate 9, photosensitive glass layers 6T, 5T, 5B, and 6B on which various conductor patterns are formed, insulating layers 7T and 7B made of an epoxy resin, magnets 8T and 8B, side electrodes 1, and the like.

A top first coil linear conductor pattern L1T is formed on the top face of the photosensitive glass layer 6T. A top second coil linear conductor pattern L2T is formed on the bottom face of the photosensitive glass layer 6T. A top third coil linear conductor pattern L3T is formed on the bottom face of the photosensitive glass layer 5T. A bottom first coil linear conductor pattern L1B is formed on the top face of the photosensitive glass layer 5B. A bottom second coil linear conductor pattern L2B is formed on the top face of the photosensitive glass layer 6B. A bottom third coil linear conductor pattern L3B is formed on the bottom face of the photosensitive glass layer 6B. These conductor patterns are patterned layers made of photosensitive Ag. Although an electrically conductive material other than Ag is usable, a material with high electrical conductivity can be used.

Conductor patterns for inter-layer connection are formed around or near the periphery of the photosensitive glass layers 6T, 5T, 5B, and 6B. Likewise, conductor patterns for inter-layer connection are formed on or near the sides of the ferrite plate 9. The side electrodes 1 illustrated in FIG. 4 are formed on the top and bottom faces and the sides of a multilayer body configured by laminating layers.

In this manner, the circulator 101 includes three coils that are insulated from one another with insulating layers (photosensitive glass layers) interposed therebetween and that intersect one another on the ferrite plate 9.

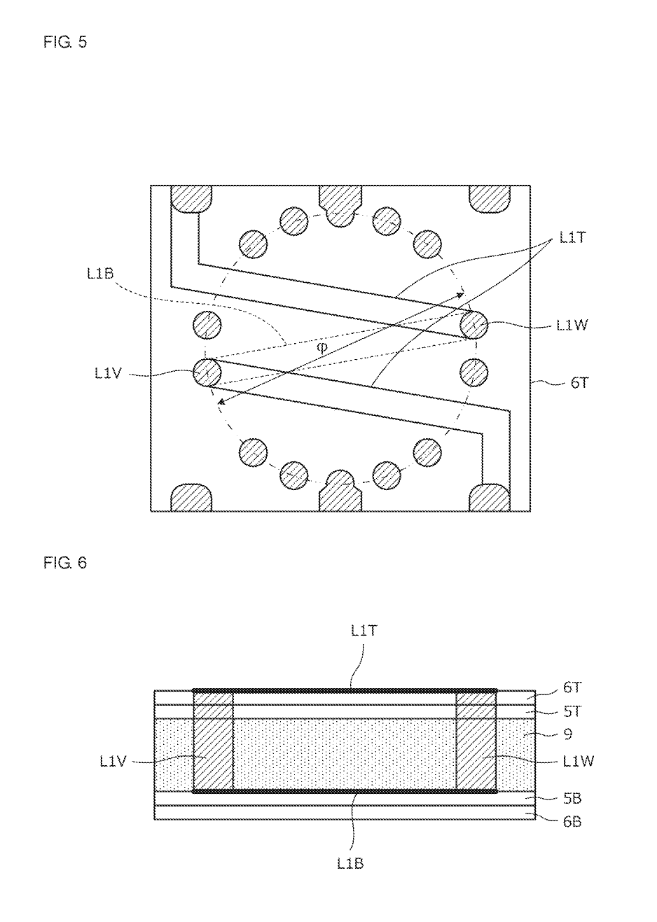

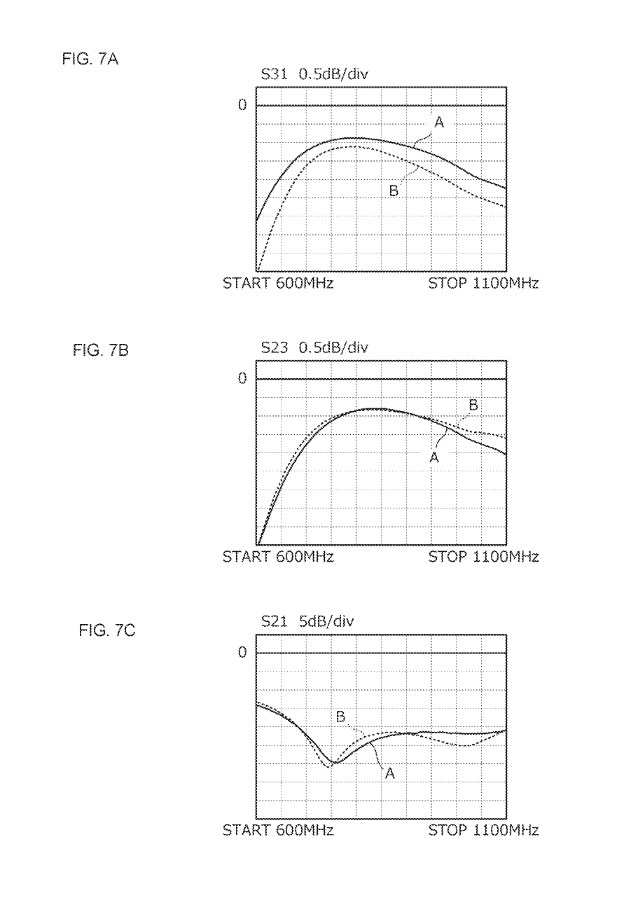

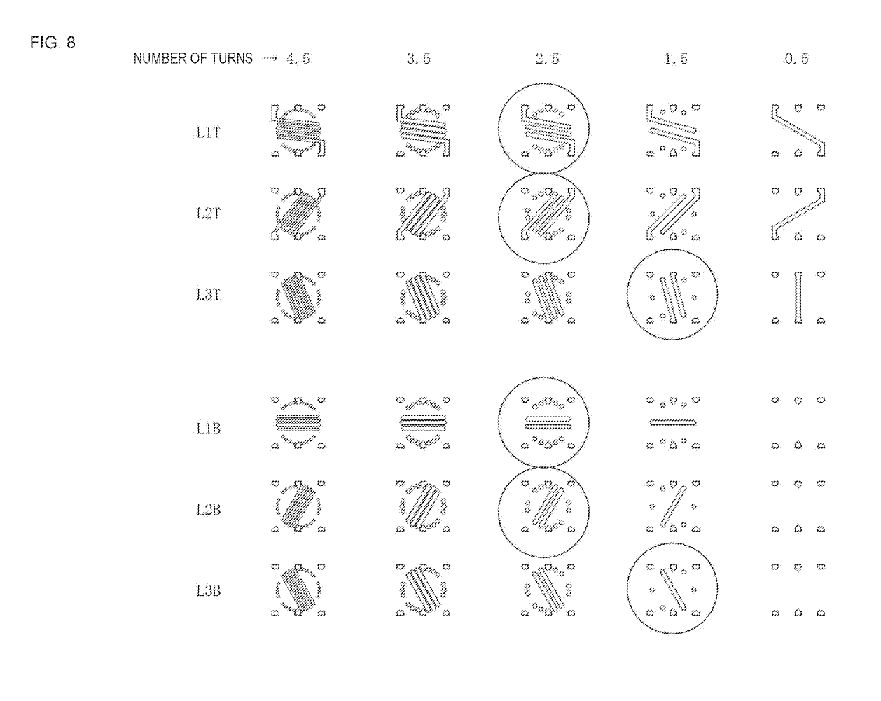

FIG. 5 is a diagram illustrating the number of turns of the first coil L1, which is a plan view illustrating first coil conductor patterns formed on the photosensitive glass layer 6T and the like. FIG. 6 is a cross-sectional view illustrating a coil opening of the first coil L1. The coil opening area of the first coil L1 is, as illustrated in FIG. 6, a cross-sectional area surrounded by the top first coil linear conductor pattern L1T, the bottom first coil linear conductor pattern L1B, and the inter-layer connection conductors L1V and L1W. The number of turns of the first coil L1 is defined by, as illustrated in FIG. 5, the number of pieces of the top first coil linear conductor pattern L1T and the bottom first coil linear conductor pattern L1B, and the number of the inter-layer connection conductors L1V and L1W.

Therefore, the inductance of the first coil L1 can be arbitrarily designed with the following parameters: the magnetic permeability of the ferrite plate 9, the length (coil diameter φ) of the linear conductor patterns L1T and L1B, the length of the inter-layer connection conductors L1V and L1W (the thickness of the ferrite plate 9), the number of turns of the coil, the line width of the top first coil linear conductor pattern L1T and the bottom first coil linear conductor pattern L1B, and the line width (diameter) of the inter-layer connection conductor L1V and L1W. Likewise, the second coil L2 and the third coil L3 can be designed in accordance with the above-mentioned parameters.

Here, the inductance of a coil is proportional to μN²S/1 where the number of turns is denoted by N, the area of the coil opening is denoted by S, the magnetic permeability is denoted by μ, and the entire length of the conductor patterns is denoted by 1. Thus, the inductance of a coil can be roughly defined using the number of turns, with which the inductance can be most easily set, and then to refine the inductance using the above-mentioned other parameters.

In the present embodiment, the inductance of the first coil L1 is less than the inductance of the second coil L2 and the third coil L3; the impedance of the first port P1 is 20Ω; and the impedance of each of the second port P2 and the third port P3 is 50Ω.

The circulator 101 of the present embodiment is used as a transmission/reception demultiplexing circuit, as illustrated in FIG. 1. Since the impedance of the first port P1 of the circulator 101 is 20Ω, if the output impedance of the power amplifier PA is 20Ω or impedance close to 20Ω, an impedance matching circuit is unnecessary between the power amplifier PA and the first port P1 of the circulator 101. More specifically, the impedance of the first port P1 of the circulator 101 is set to the complex conjugate or close to the complex conjugate of the impedance of the power amplifier PA. For example, when the impedance of the power amplifier PA is (20Ω−j10Ω), the impedance of the first port P1 of the circulator 101 is set to (20Ω+j10Ω) or impedance close to (20Ω+j10Ω). In doing so, the power amplifier PA and the first port (transmission port) P1 of the circulator 101 are impedance-matched.

According to the present embodiment, because the power amplifier PA is directly connected to the first port P1 of the circulator 101, a power loss caused by an impedance matching circuit if the impedance matching circuit were provided between the first port P1 of the circulator 101 and the power amplifier PA can be avoided.

FIGS. 7A, 7B, and 7C are diagrams illustrating the characteristics of the circulator 101 according to the first embodiment. FIG. 7A is a diagram illustrating the passage loss characteristics from the first port (transmission port) P1 to the third port (antenna port) P3. FIG. 7B is a diagram illustrating the passage loss characteristics from the third port (antenna port) P3 to the second port (reception port) P2. FIG. 7C is a diagram illustrating the isolation characteristics between the first port (transmission port) P1 and the second port (reception port) P2.

In FIGS. 7A, 7B, and 7C, characteristic curve A indicates the characteristics of the circulator 101 according to the first embodiment, and characteristic curve B indicates the characteristics of a transmission/reception demultiplexing circuit of a comparative example. In these figures, the horizontal axis represents frequencies from 600 MHz to 1100 MHz. One division of a scale on the vertical axis in FIGS. 7A and 7B is 0.5 dB, and one division of a scale on the vertical axis in FIG. 7C is 5 dB.

The transmission/reception demultiplexing circuit of the above-mentioned comparative example is a circuit including a conventional circulator designed in such a manner that its first port P1, second port P2, and third port P3 will all have 50Ω, and a 50-Ω-20-Ω impedance matching circuit connected to the first port (transmission port) P1.

As illustrated in FIG. 7A, the passage loss from the first port (transmission port) P1 to the third port (antenna port) P3 is lower by about 0.5 dB than that in the comparative example. This is because there is no loss caused by the above-mentioned impedance matching circuit.

As illustrated in FIG. 7B, the passage loss from the third port (antenna port) P3 to the second port (reception port) P2 is substantially the same as that in the comparative example. That is, setting the impedance of the first port (transmission port) P1 to a value other than 50Ω has no effect on the other ports.

Furthermore, as illustrated in FIG. 7C, the isolation between the first port (transmission port) P1 and the second port (reception port) P2 is substantially the same as that in the comparative example. That is, setting the impedance of the first port (transmission port) P1 to a value other than 50Ω has no effect on the isolation characteristics.

Although FIGS. 3 and 4 illustrate an example where the number of turns of the first coil L1 is 1.5 and the number of turns of the second coil L2 and the third coil L3 is 2.5, these numbers of turns can be arbitrarily selected within a certain range. FIG. 8 is a diagram illustrating selection of the number of turns of each of the first coil L1, the second coil L2, and the third coil L3. In the example illustrated in FIG. 8, a conductor pattern with a number of turns from 0.5 to 4.5 is illustrated for each of the top first coil linear conductor pattern L1T, the top second coil linear conductor pattern L2T, the top third coil linear conductor pattern L3T, the bottom first coil linear conductor pattern L1B, the bottom second coil linear conductor pattern L2B, and the bottom third coil linear conductor pattern L3B. Patterns enclosed by circles in FIG. 8 correspond to the patterns illustrated in FIGS. 3 and 4. In this manner, the number of turns of each of the three coils L1, L2, and L3 can be selected.

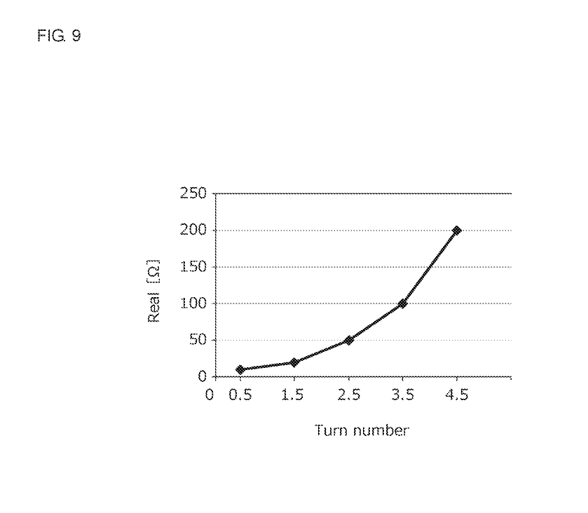

FIG. 9 is a diagram illustrating the schematic relationship between the number of turns of a coil and port impedance defined by the number of turns. The horizontal axis represents the number of turns of a coil, and the vertical axis represents the real part of a port impedance. For example, when the port impedance is set to 50Ω, the number of turns is set to 2.5; and, when the port impedance is set to 20Ω, the number of turns is set to 1.5.

Because the inductance of a coil changes in accordance with, besides the number of turns of the coil, the magnetic permeability of the ferrite plate 9, the length of the linear conductor patterns, the length of the inter-layer connection conductors, the line width of the linear conductor patterns, and the line width (diameter) of the inter-layer connection conductors, the inductance of the coil is defined by also taking into consideration these parameters, thereby defining the impedance of each port.

According to the present embodiment, the following advantages may be achieved.

(1) Because the circulator has the impedance conversion function, an impedance matching circuit for matching the impedance of a circuit connected to a certain port of the circulator to, for example, 50Ω is unnecessary. That is, because the configuration requires no impedance matching circuit outside the circulator, the number of components is reduced, thereby reducing the size and cost. In the example illustrated in FIG. 2, for the port P1, because no capacitor for impedance matching is connected to the first coil L1 in the interior of the circulator 101 as well, the size and cost can be further reduced.

(2) Because there is no reactance element for impedance matching between the power amplifier and the circulator, the power amplifier and the antenna can be matched over a wide band.

(3) Because there is no insertion loss to be caused by an overlapping impedance matching circuit, the passage loss of the entire circuit can be reduced.

### Second Embodiment

The second embodiment will discuss an example of a circulator in which the first port (transmission port) P1 has 75Ω, and the second port (reception port) P2 and the third port (antenna port) P3 each have 50Ω.

Since the impedance of the first port P1 of the circulator of the present embodiment is 75Ω, in the case of applying the circulator of the present embodiment to the transmission/reception demultiplexing circuit illustrated in FIG. 1, if the output impedance of the power amplifier PA is 75Ω or impedance close to 75Ω, an impedance matching circuit is unnecessary between the power amplifier PA and the first port P1 of the circulator. That is, the impedance of the first port P1 of the circulator is set to the complex conjugate or close to the complex conjugate of the impedance of the power amplifier PA. In doing so, the power amplifier PA and the first port (transmission port) P1 of the circulator are impedance-matched.

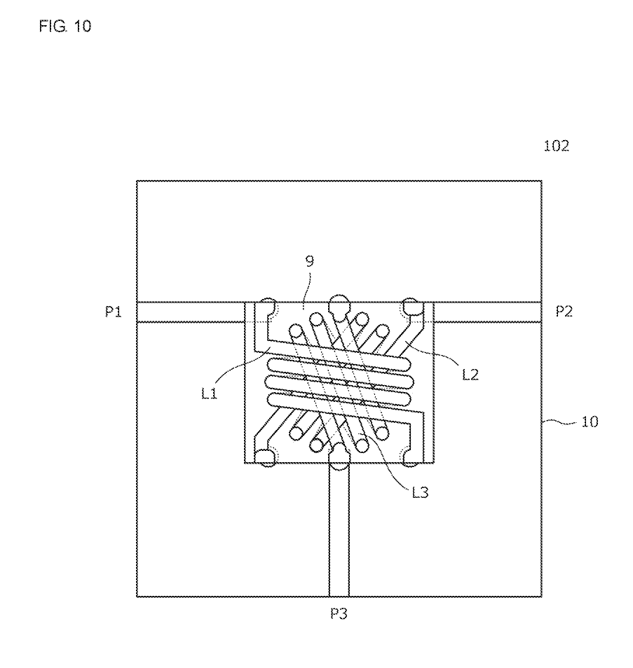

FIG. 10 is a plan view illustrating the structure of a core portion of a circulator 102 according to the present embodiment. The circulator 102 includes the ferrite plate 9, and the first coil L1, the second coil L2, and the third coil L3, which are formed on the ferrite plate 9. The circulator 102 is different in the number of turns of the first coil L1 from the circulator 101 illustrated in FIG. 3 of the first embodiment. Whereas the number of turns of the second coil L2 and the third coil L3 is 2.5, the number of turns of the first coil L1 is 3.5.

FIGS. 11A, 11B, and 11C are diagrams illustrating the characteristics of the circulator 102 according to the second embodiment. FIG. 11A is a diagram illustrating the passage loss characteristics from the first port (transmission port) P1 to the third port (antenna port) P3. FIG. 11B is a diagram illustrating the passage loss characteristics from the third port (antenna port) P3 to the second port (reception port) P2. FIG. 11C is a diagram illustrating the isolation characteristics between the first port (transmission port) P1 and the second port (reception port) P2.

In FIGS. 11A, 11B, and 11C, characteristic curve A indicates the characteristics of the circulator 102 according to the second embodiment, and characteristic curve B indicates the characteristics of a transmission/reception demultiplexing circuit of a comparative example. The frequency range on the horizontal axis and the scale on the vertical axis are the same as those illustrated in FIGS. 7A, 7B, and 7C of the first embodiment.

The transmission/reception demultiplexing circuit of the above-mentioned comparative example is a circuit including a conventional circulator designed in such a manner that its first port P1, second port P2, and third port P3 will all have 50Ω, and a 50-Ω-75-Ω impedance matching circuit connected to the first port (transmission port) P1.

As illustrated in FIG. 11A, the passage loss from the first port (transmission port) P1 to the third port (antenna port) P3 is lower by about 0.2 dB than that in the comparative example. This is because there is no loss caused by the above-mentioned impedance matching circuit.

As illustrated in FIG. 11B, the passage loss from the third port (antenna port) P3 to the second port (reception port) P2 is substantially the same as that in the comparative example. That is, setting the impedance of the first port (transmission port) P1 to a value other than 50Ω has no effect on the other ports.

Furthermore, as illustrated in FIG. 11C, the isolation between the first port (transmission port) P1 and the second port (reception port) P2 is improved from that in the comparative example over a wide frequency band.

### Third Embodiment

A third embodiment will discuss an example of a circulator in which the second port (reception port) P2 has 120Ω, and the first port (transmission port) P1 and the third port (antenna port) P3 each have 50Ω.

Since the impedance of the second port P2 of the circulator of the present embodiment is 120Ω, in the case of applying the circulator of the present embodiment to the transmission/reception demultiplexing circuit illustrated in FIG. 1, if the impedance of the band-pass filter 20 is 120Ω or impedance close to 120Ω, an impedance matching circuit is unnecessary between the band-pass filter 20 and the second port P2 of the circulator. That is, the impedance of the second port P2 of the circulator is set to the complex conjugate or close to the complex conjugate of the impedance of the band-pass filter 20. In doing so, the band-pass filter 20 and the second port (reception port) P2 of the circulator are impedance-matched.

Depending on the design of the band-pass filter 20, excellent filter characteristics, such as reduction of the insertion loss, may be achieved by designing the band-pass filter 20 to have an impedance of 120Ω, instead of designing the impedance to match 50Ω. In such a case, the circulator of the present embodiment is applied.

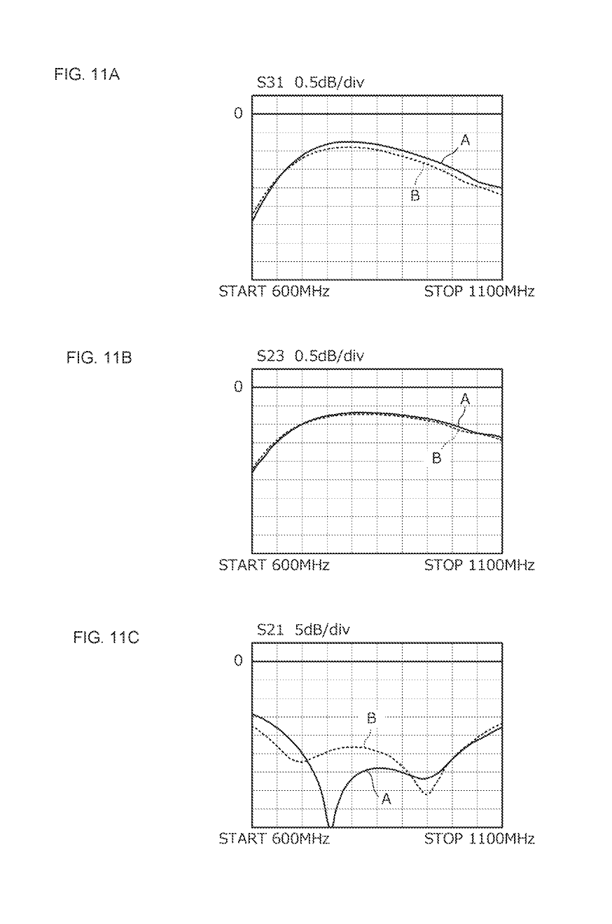

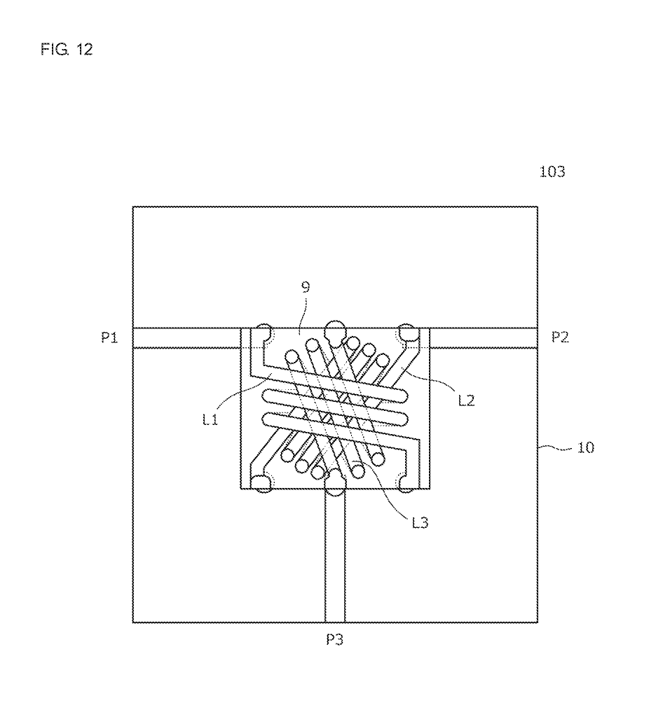

FIG. 12 is a plan view of a circulator 103 according to the present embodiment. The circulator 103 includes the ferrite plate 9, and the first coil L1, the second coil L2, and the third coil L3, which are formed on the ferrite plate 9. Whereas the number of turns of the first coil L1 and the third coil L3 is 2.5, the number of turns of the second coil L2 is 3.5.

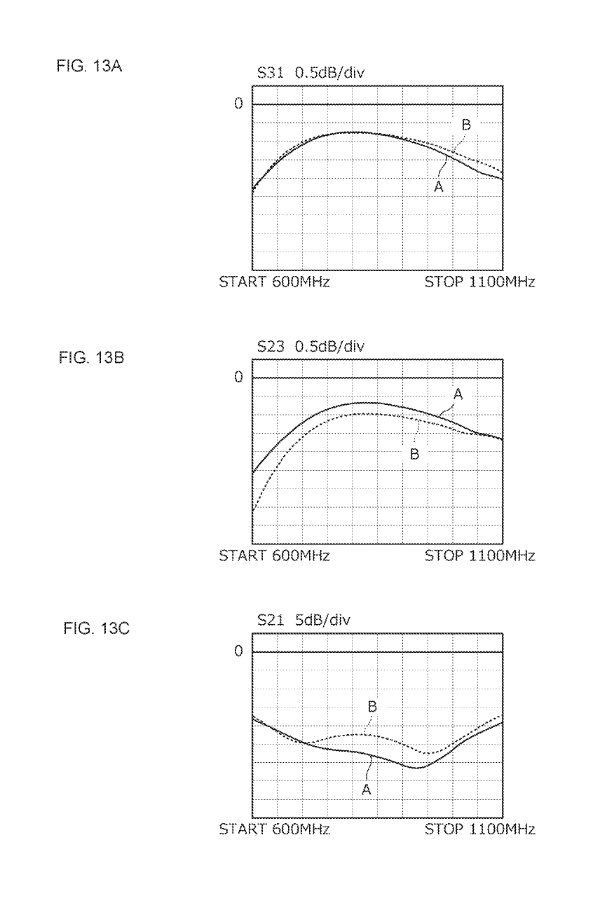

FIGS. 13A, 13B, and 13C are diagrams illustrating the characteristics of the circulator 103 according to the third embodiment. FIG. 13A is a diagram illustrating the passage loss characteristics from the first port (transmission port) P1 to the third port (antenna port) P3. FIG. 13B is a diagram illustrating the passage loss characteristics from the third port (antenna port) P3 to the second port (reception port) P2. FIG. 13C is a diagram illustrating the isolation characteristics between the first port (transmission port) P1 and the second port (reception port) P2.

In FIGS. 13A, 13B, and 13C, characteristic curve A indicates the characteristics of the circulator 103 according to the third embodiment, and characteristic curve B indicates the characteristics of a transmission/reception demultiplexing circuit of a comparative example. The frequency range on the horizontal axis and the scale on the vertical axis are the same as those illustrated in FIGS. 7A, 7B, and 7C of the first embodiment.

The transmission/reception demultiplexing circuit of the above-mentioned comparative example is a circuit including a conventional circulator designed in such a manner that its first port P1, second port P2, and third port P3 will all have 50Ω, and a 50-Ω-120-Ω impedance matching circuit connected to the second port (reception port) P2.

As illustrated in FIG. 13B, the passage loss from the third port (antenna port) P3 to the second port (reception port) P2 is lower by about 0.4 dB than that in the comparative example. This is because there is no loss caused by the above-mentioned impedance matching circuit.

As illustrated in FIG. 13A, the passage loss from the first port (transmission port) P1 to the third port (antenna port) P3 is substantially the same as that in the comparative example. That is, setting the impedance of the second port (reception port) P2 to a value other than 50Ω has no effect on the other ports.

Furthermore, as illustrated in FIG. 13C, the isolation between the first port (transmission port) P1 and the second port (reception port) P2 is improved from that in the comparative example over a wide frequency band.

### Fourth Embodiment

A fourth embodiment will discuss an example of a circulator in which the second port (reception port) P2 has 20Ω, and the first port (transmission port) P1 and the third port (antenna port) P3 each have 50Ω.

Because the impedance of the second port P2 of the circulator of the present embodiment is 20Ω, the circulator of the present embodiment is applied to, in the transmission/reception demultiplexing circuit illustrated in FIG. 1, a transmission/reception demultiplexing circuit in which there is no band-pass filter 20, and the low-noise amplifier LNA is directly connected to the second port P2 of the circulator. When the impedance of the low-noise amplifier LNA is designed as 20Ω or impedance close to 20Ω, an impedance matching circuit is unnecessary between the low-noise amplifier LNA and the second port P2 of the circulator. That is, the impedance of the second port P2 of the circulator is set to the complex conjugate or close to the complex conjugate of the impedance of the low-noise amplifier LNA. In doing so, the low-noise amplifier LNA and the second port (reception port) P2 of the circulator are impedance-matched.

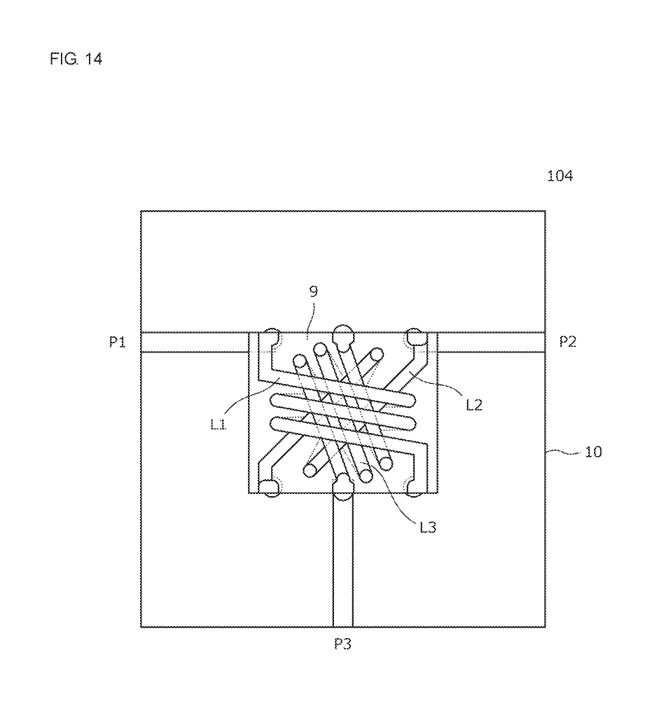

FIG. 14 is a plan view of a circulator 104. The circulator 104 includes the ferrite plate 9, and the first coil L1, the second coil L2, and the third coil L3, which are formed on the ferrite plate 9. Whereas the number of turns of the first coil L1 and the third coil L3 is 2.5, the number of turns of the second coil L2 is 1.5.

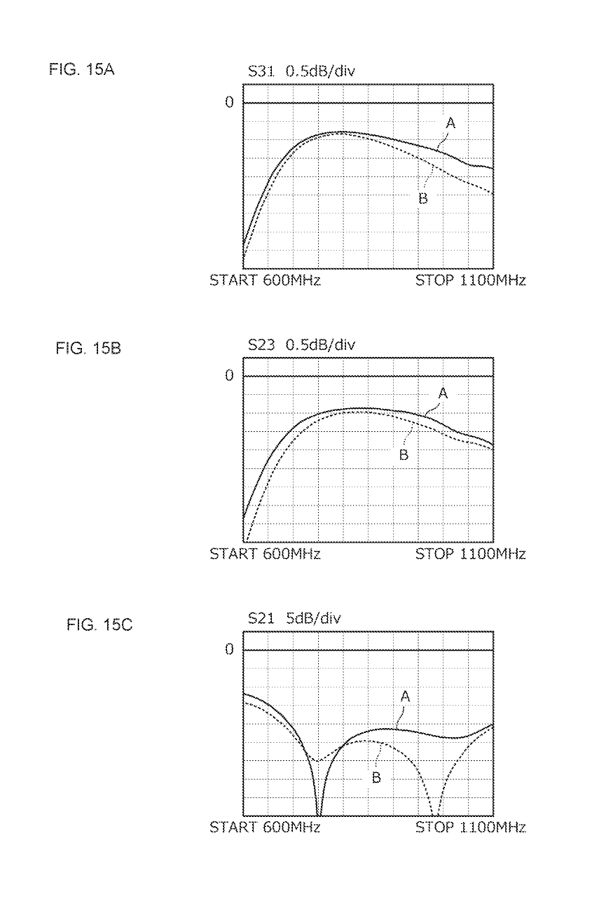

FIGS. 15A, 15B, and 15C are diagrams illustrating the characteristics of the circulator 104 according to the fourth embodiment. FIG. 15A is a diagram illustrating the passage loss characteristics from the first port (transmission port) P1 to the third port (antenna port) P3. FIG. 15B is a diagram illustrating the passage loss characteristics from the third port (antenna port) P3 to the second port (reception port) P2. FIG. 15C is a diagram illustrating the isolation characteristics between the first port (transmission port) P1 and the second port (reception port) P2.

In FIGS. 15A, 15B, and 15C, characteristic curve A indicates the characteristics of the circulator 104 according to the fourth embodiment, and characteristic curve B indicates the characteristics of a transmission/reception demultiplexing circuit of a comparative example. The frequency range on the horizontal axis and the scale on the vertical axis are the same as those illustrated in FIGS. 7A, 7B, and 7C of the first embodiment.

The transmission/reception demultiplexing circuit of the above-mentioned comparative example is a circuit including a conventional circulator designed in such a manner that its first port P1, second port P2, and third port P3 will all have 50Ω, and a 50-Ω-20-Ω impedance matching circuit connected to the second port (reception port) P2.

As illustrated in FIG. 15B, the passage loss from the third port (antenna port) P3 to the second port (reception port) P2 is lower by about 0.3 dB than that in the comparative example. This is because there is no loss caused by the above-mentioned impedance matching circuit.

As illustrated in FIG. 15A, the passage loss from the first port (transmission port) P1 to the third port (antenna port) P3 is substantially the same as that in the comparative example. That is, setting the impedance of the second port (reception port) P2 to a value other than 50Ω has no effect on the other ports.

Furthermore, as illustrated in FIG. 15C, the isolation between the first port (transmission port) P1 and the second port (reception port) P2 is such that characteristics that are equivalent to those in the comparative example are achieved over a wide frequency band.

### Fifth Embodiment

A fifth embodiment will discuss an example of a circulator in which the first port (transmission port) P1 has an impedance that is greater than or equal to 5Ω and less than or equal to 30Ω (such as 20Ω), the second port (reception port) P2 has an impedance that is greater than or equal to 55Ω and less than or equal to 150Ω (such as 100Ω) and the third port (antenna port) P3 has an impedance that is 50Ω.

Since the impedance of the first port P1 of the circulator of the present embodiment is greater than or equal to 5Ω and less than or equal to 30Ω (such as 20Ω), in the case of applying the circulator of the present embodiment to the transmission/reception demultiplexing circuit illustrated in FIG. 1, if the impedance of the power amplifier PA is greater than or equal to 5Ω and less than or equal to 30Ω, an impedance matching circuit is unnecessary between the power amplifier PA and the first port P1 of the circulator. If the impedance of the band-pass filter 20 is greater than or equal to 55Ω and less than or equal to 150Ω, an impedance matching circuit is unnecessary between the band-pass filter 20 and the second port P2 of the circulator. That is, the impedance of the first port P1 of the circulator is set to the complex conjugate or close to the complex conjugate of the impedance of the power amplifier PA. In addition, the impedance of the second port P2 of the circulator is set to the complex conjugate or close to the complex conjugate of the impedance of the band-pass filter 20. In doing so, the power amplifier PA and the first port (transmission port) P1 of the circulator are impedance-matched, and the band-pass filter 20 and the second port (reception port) P2 of the circulator are impedance-matched.

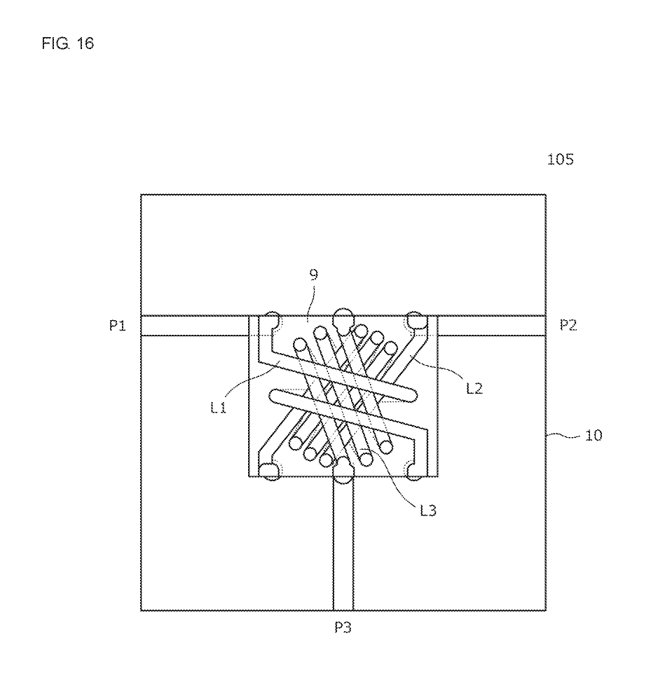

FIG. 16 is a plan view of a circulator 105. The circulator 105 includes the ferrite plate 9, and the first coil L1, the second coil L2, and the third coil L3, which are formed on the ferrite plate 9. The number of turns of the first coil L1 is 1.5, the number of turns of the second coil L2 is 2.5, and the number of turns of the third coil L3 is 3.5.

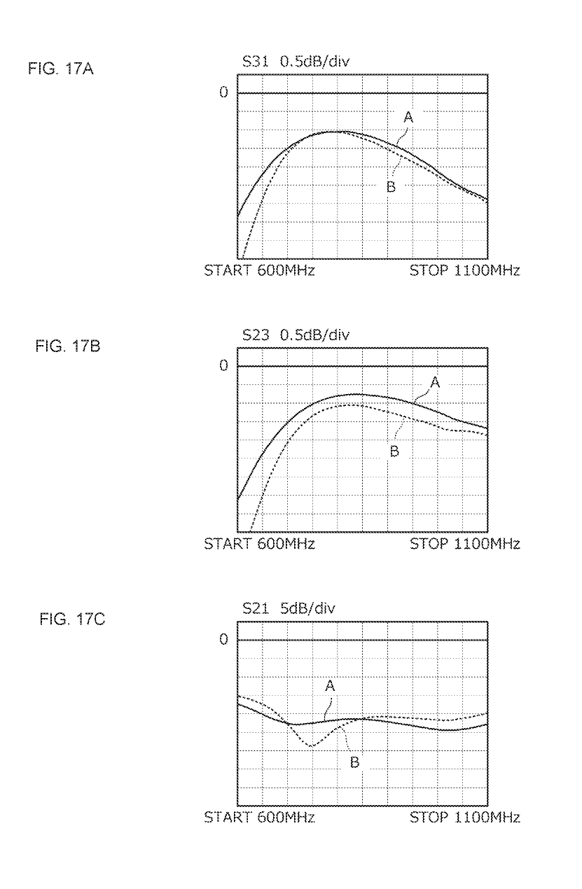

FIGS. 17A, 17B, and 17C are diagrams illustrating the characteristics of the circulator 105 according to the fifth embodiment. FIG. 17A is a diagram illustrating the passage loss characteristics from the first port (transmission port) P1 to the third port (antenna port) P3. FIG. 17B is a diagram illustrating the passage loss characteristics from the third port (antenna port) P3 to the second port (reception port) P2. FIG. 17C is a diagram illustrating the isolation characteristics between the first port (transmission port) P1 and the second port (reception port) P2.

In FIGS. 17A, 17B, and 17C, characteristic curve A indicates the characteristics of the circulator 105 according to the fifth embodiment, and characteristic curve B indicates the characteristics of a transmission/reception demultiplexing circuit of a comparative example. The frequency range on the horizontal axis and the scale on the vertical axis are the same as those illustrated in FIGS. 7A, 7B, and 7C of the first embodiment.

The transmission/reception demultiplexing circuit of the above-mentioned comparative example is a circuit including a conventional circulator designed in such a manner that its first port P1, second port P2, and third port P3 will all have 50Ω, a 50-Ω-20-Ω impedance matching circuit connected to the first port (transmission port) P1, and a 50-Ω-100-Ω impedance matching circuit connected to the second port (reception port) P2.

As illustrated in FIG. 17A, the passage loss from the first port (transmission port) P1 to the third port (antenna port) P3 is lower by about 0.2 dB than that in the comparative example. As illustrated in FIG. 17B, the passage loss from the third port (antenna port) P3 to the second port (reception port) P2 is lower by about 0.4 dB than that in the comparative example. This is because there is no loss caused by the above-mentioned impedance matching circuits.

In addition, as illustrated in FIG. 17C, the isolation between the first port (transmission port) P1 and the second port (reception port) P2 is such that characteristics that are equivalent to those in the comparative example are achieved over a wide frequency band.

The correspondence between the first port P1, the second port P2, and the third port P3 according to the present disclosure and the transmission port, the reception port, and the antenna port discussed in each embodiment is only exemplary, and an RF circuit connected to each of the first port P1, the second port P2, and the third port P3 is defined in accordance with a circuit to apply.

Although the above-described examples have discussed the examples where the third port (antenna port) P3 has 50Ω, a circulator where the third port P3 has an impedance that is greater than or equal to 5Ω and less than or equal to 25Ω (such as 10Ω) can be configured in the same manner. In this case, if the impedance of the antenna 200 is greater than or equal to 5Ω and less than or equal to 25Ω (such as 10Ω), an impedance matching circuit is unnecessary between the antenna 200 and the third port P3 of the circulator. That is, the impedance of the third port P3 of the circulator is set to the complex conjugate or close to the complex conjugate of the impedance of the antenna 200. In doing so, the antenna 200 and the third port (antenna port) P3 of the circulator are impedance-matched.

Finally, the descriptions of the above-described embodiments are only exemplary in all respects and are not construed to be limiting. It is clear that modifications or changes may be made by those skilled in the art. For example, a partial replacement or combination of configurations discussed in different embodiments is possible. The scope of the present invention is defined not by the above-described embodiments, but by the appended claims. In addition, it is intended that equivalents to the scope of the claims and all changes that are within the scope of the claims be included within the scope of the present invention.

### REFERENCE SIGNS LIST

C2, Cs2, C3, Cs3, and Cg: capacitors
L1: first coil
L1B: bottom first coil linear conductor pattern
L1T: top first coil linear conductor pattern
L1V and L1W: inter-layer connection conductors
L2: second coil
L2B: bottom second coil linear conductor pattern
L2T: top second coil linear conductor pattern
L3: third coil
L3B: bottom third coil linear conductor pattern
L3T: top third coil linear conductor pattern
Lg: inductor
LNA: low-noise amplifier
P1: first port
P2: second port
P3: third port
PA: power amplifier
1: side electrodes
6T, 5T, 5B, and 6B: photosensitive glass layers
7T and 7B: insulating layers
8T and 8B: magnets
9: ferrite plate
10: multilayer substrate
20: band-pass filter
100: front-end circuit
101 to 105: circulators
110: RFIC
120: BBIC
130: input/output circuit
200: antenna
210: antenna circuit
300: communication apparatus

1. A circulator comprising:
a ferrite plate;
a permanent magnet that applies a direct current (DC) magnetic field to the ferrite plate;
a first coil, a second coil, and a third coil arranged on the ferrite plate while the first coil, the second coil, and the third coil being insulated from one another, the first coil, the second coil, and the third coil having coil axes intersecting one another;
a first port that is electrically continuous with the first coil;
a second port that is electrically continuous with the second coil; and
a third port that is electrically continuous with the third coil, wherein:
the permanent magnet applies a DC magnetic field to the ferrite plate such that a signal input to the first port will be output to the third port and a signal input to the third port will be output to the second port, and
an inductance of the first coil or the second coil is different from an inductance of the third coil, and an impedance of the first port or the second port is not 50Ω.

2. The circulator according to claim 1, wherein the impedance of the first port is less than 50Ω, and the impedance of the second port is 50Ω or is higher than the impedance of the first port.

3. The circulator according to claim 1, wherein the impedance of the first port is a value that exceeds 50Ω, and the impedance of the second port is 50Ω or is lower than the impedance of the first port.

4. The circulator according to claim 1, wherein the impedance of the first port is less than 50Ω, and the impedance of the second port is a value that exceeds 50Ω.

5. The circulator according to claim 4, wherein an impedance of the third port is less than 50Ω.

6. The circulator according to claim 1, wherein:
the impedance of the first port is greater than or equal to 5Ω and less than or equal to 30Ω,
the impedance of the second port is greater than or equal to 55Ω and less than or equal to 150Ω, and
an impedance of the third port is greater than or equal to 5Ω and less than or equal to 25Ω.

7. The circulator according to claim 1, wherein the first coil or the second coil has a different number of turns of the coil from that of the third coil.

8. The circulator according to claim 1, wherein the first coil or the second coil has a different coil diameter from that of the third coil.

9. The circulator according to claim 1, wherein the first coil or the second coil has a different line width from the line width of the third coil.

10. A front-end circuit comprising: the circulator of claim 1 including the first port to which a transmission signal is input, the second port from which a reception signal is output, and the third port connected to an antenna; and a power amplifier that outputs a transmission signal.

11. The front-end circuit according to claim 10, wherein an output of the power amplifier is directly connected to the first port.

12. A front-end circuit comprising: the circulator according to claim 1 including the first port to which a transmission signal is input, the second port from which a reception signal is output, and the third port connected to an antenna, and a low-noise amplifier that receives a reception signal, wherein an input of the low-noise amplifier is directly connected to the second port.

13. An antenna circuit comprising: the circulator according to claim 1 including the first port to which a transmission signal is input, the second port from which a reception signal is output, and the third port connected to an antenna; and the antenna, wherein the antenna is directly connected to the third port.

14. A communication apparatus comprising: the circulator according to claim 1 including the first port to which a transmission signal is input, the second port from which a reception signal is output, and the third port connected to an antenna; a power amplifier that outputs a transmission signal; and an RFIC that outputs a signal to be supplied to the power amplifier, wherein an output of the power amplifier is directly connected to the first port.

15. The circulator according to claim 2, wherein the first coil or the second coil has a different number of turns of the coil from that of the third coil.

16. The circulator according to claim 3, wherein the first coil or the second coil has a different number of turns of the coil from that of the third coil.

17. The circulator according to claim 4, wherein the first coil or the second coil has a different number of turns of the coil from that of the third coil.

18. The circulator according to claim 5, wherein the first coil or the second coil has a different number of turns of the coil from that of the third coil.

19. The circulator according to claim 6, wherein the first coil or the second coil has a different number of turns of the coil from that of the third coil.

20. The circulator according to claim 2, wherein the first coil or the second coil has a different coil diameter from that of the third coil.
